(19) United States
(12) Patent Application Publication
(10) Pub. No.: US 2006/0104846 A1
(43) Pub. Date: May 18, 2006

(54) Scroll compressor

(75) Inventor: Seon-Woong Hwang, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/234,131

(22) Filed: Sep. 26, 2005

(30) Foreign Application Priority Data
Nov. 12, 2004 (KR) 92615/2004

(51) Int. Cl. F01C 20/18; F04C 2/00; F03C 4/00

(52) U.S. Cl. 418/55.1; 418/22; 418/55.3

(57) ABSTRACT

An orbiting scroll compressor includes: a frame fixed in a casing; a driving motor fixed in the casing and supplying a driving force; a fixed scroll fixed in the casing; an orbiting scroll forming a first compression space as its one side is interlocked with the fixed scroll, and orbiting by being eccentrically coupled to a driving shaft connected to the driving motor; an orbiting vane protruding from the other side of the orbiting scroll to a predetermined height and forming a second compression space with a vane receiving groove of the frame; a capacity varying unit communicating with the second compression space and varying its capacity; and a control unit connected to the capacity varying unit and controlling the capacity varying unit. Thus, as the orbiting vane is provided, compression performance is improved while maintaining the size of the compressor. Also, because a compression capacity is varied to allow the optimum operation according to external conditions, the efficiency of the compressor can be improved.

### BACKGROUND OF THE INVENTION

1. Field of the Invention

The present invention relates to a scroll compressor, and particularly, to a scroll compressor to improve compression performance while maintaining the size of a compressor and to improve efficiency of the compressor by varying a compression capacity and thusly allowing the optimum operation according to external conditions.

2. Description of the Background Art

In general, a compressor converts electric energy into kinetic energy and compresses a refrigerant gas by the kinetic energy. The compressor is a core factor constituting a freezing cycle system, and there are various kinds of compressors according to a compression mechanism for compressing a refrigerant, such as a rotary compressor, a scroll compressor, a reciprocal compressor and the like. The freezing cycle system including such a compressor is being used in a refrigerator, an air conditioner, a showcase and the like.

In the scroll compressor of such compressors, a driving force of a driving motor is transferred to an orbiting scroll, and the orbiting scroll orbits, interlocked with a fixed scroll, thereby continuously taking in, compressing and discharging a gas. The orbiting scroll and the fixed scroll are respectively provided with wraps of an involute shape, and a plurality of compression pockets are formed by the wrap of the fixed scroll and the wrap of the orbiting scroll. As the compression pockets move toward a discharge hole through which a gas is discharged by orbiting of the orbiting scroll, their volumes are contracted, and the gas is compressed.

In general, the compression pockets are formed as a pair symmetrically on the basis of a discharge hole. The two compression pockets formed as a pair have the same volume. As the pair of compression pockets move toward the discharge hole by gas taken in from an intake side, another pair of compression pockets are formed at the intake side. Such processes are repetitively performed.

FIG. 1 is proposed to describe the structure of the scroll compressor in more detail. FIG. 1 is a sectional view which illustrates one example of the conventional scroll compressor.

As shown, the scroll compressor includes a casing 10 provided with an intake pipe SP and a discharge pipe DP, a main frame 20 and a sub-frame 30 fixedly coupled within the casing 10 and spaced apart from each other at a certain is interval therebetween in a vertical direction, a fixed scroll 40 fixedly coupled to the casing 10 and placed above the main frame 20, an orbiting scroll 50 positioned between the fixed scroll 40 and the main frame 20 and interlocked with the fixed scroll 40 to orbit, an oldham ring 60 positioned between the orbiting scroll 50 and the main frame 20 and preventing rotation of the orbiting scroll 50, a driving motor 100 fixedly coupled to the casing 10, placed between the main frame 20 and the sub-frame 30 and generating a driving force, a rotary shaft 70 transferring the driving force of the driving motor 100 to the orbiting scroll 50, and a valve assembly 80 mounted on the fixed scroll 40.

The main frame 20 includes a shaft insertion hole 22 formed at a frame body portion 21 having a predetermined shape, in which the rotary shaft 70 is penetratingly inserted, a boss insertion groove 23 connected to the shaft insertion hole 22 and having an inner diameter greater than that of the shaft insertion hole 22, and a bearing surface 24 formed at an upper surface of the frame body portion 21, at which the orbiting scroll 50 is supported.

The fixed scroll 40 includes a body portion 41 having a predetermined shape, a wrap 42 having an involute shape and formed at one surface of the body portion 41 with a certain thickness and length, a discharge hole 43 penetratingly formed at the center of the body portion 41 and an intake hole 44 formed at one side of the body portion 41.

The orbiting scroll 50 includes a circular plate 51 having a certain thickness and area, a wrap 52 having an involute shape and formed at one surface of the circular plate 51 with a certain thickness and height, a boss portion 53 protrudingly formed to a certain height at the center of the other surface of the circular plate 51, and a shaft insertion groove 54 formed inside the boss portion 53 to a certain depth, in which part of the rotary shaft 70 is inserted.

The orbiting scroll 50 forms a compression pocket (P) such that its wrap 52 is interlocked with the wrap 42 of the fixed scroll 40, and the boss portion 53 of the orbiting scroll 50 is inserted in the boss insertion groove 23 of the main frame 20. The circular plate 51 of the orbiting scroll 50 is coupled between the fixed scroll 40 and the main frame 20 such that one surface of the circular plate 51 is supported at the bearing surface 24 of the main frame.

The rotary shaft 70 includes a shaft portion 71 having a certain length, an eccentric portion 72 extending from one side of the shaft portion 71 to a certain length to be eccentric from the center of the shaft portion 71, and an oil path 73 penetratingly formed at the shaft portion 71 and the eccentric portion 72.

The shaft portion 71 of the rotary shaft 70 is coupled to the driving motor 100. One side of the shaft portion 71 of the rotary shaft is penetratingly inserted in the shaft insertion hole 22 of the main frame 20, and its eccentric portion 72 is inserted in the shaft insertion groove 54 of the orbiting scroll.

An eccentric bush 90 having a predetermined shape is inserted in the eccentric portion 72 of the rotary shaft 70, and a fixed bush 92 which slidingly comes into contact with the eccentric bush 90 is fixedly coupled to an inner wall of the shaft insertion groove 54 of the orbiting scroll.

Oil is filled at a lower portion of the casing 10.

Undescribed reference numeral 110 is a stator, 120 is a rotor, 130 is a balance weight, 140 is an oil feeder, 150 is a discharge cover and S is a discharge space.

The operation of the scroll compressor will now be described.

When power is applied to a scroll compressor, a rotary force is generated from the driving motor 100 by the operation of the driving motor 100 and is transferred to the orbiting scroll 50 through the rotary shaft 70. As the rotary force of the rotary shaft 70 is transferred to the orbiting scroll 50, the orbiting scroll 50 coupled to the eccentric portion 72 of the rotary shaft orbits about an axis of the rotary shaft 70. Because the rotation of the orbiting scroll 50 is prevented by the oldham ring 60, the orbiting scroll 50 can orbit.

As the wrap 52 of the orbiting scroll orbits, interlocked with the wrap 42 of the fixed scroll by the orbiting of the orbiting scroll 50, a plurality of compression pockets (P) formed by the wrap 52 of the orbiting scroll and the wrap 42 of the fixed scroll move toward a central portion of the fixed scroll 40 and the orbiting scroll 50, changing their volumes. Thusly, a gas is taken in, compressed and then is discharged through the discharge hole 43 of the fixed scroll.

The oil filled in the lower portion of the casing flows through the oil path 73 of the rotary shaft by the rotation of the rotary shaft 70, thereby being supplied to components that slide.

According to the rotation of the rotary shaft 70, the eccentric portion 72 of the rotary shaft rotates, wherein a radius of the rotation of the eccentric portion 72 is an eccentric distance between the eccentric portion 72 and the center of the shaft portion 71 of the rotary shaft. The rotation of the eccentric portion 72 of the rotary shaft is transferred to the boss portion 53 of the orbiting scroll, so that the orbiting scroll 50 orbits. The eccentric bush 90 inserted in the eccentric portion 72 prevents direct friction between the eccentric portion 72 of the rotary shaft and the boss portion 53 of the orbiting scroll, and stably maintains the rotation of the rotary shaft 70.

In case of the air conditioner employing the freezing cycle system having such a compressor, it is required to vary a capacity of the compressor in order to reduce power consumption of the air conditioner according to the changing weather.

As a conventional mechanism for varying the capacity of the compressor, a method of controlling revolutions of the driving motor constituting the compressor is being used. However, if an inverter is used therefor, a unit cost of manufacture can be increased because the inverter is normally expensive. For this reason, there is a need to implement capacity variation while a constant speed motor which is relatively cheap is used.

Also, a method of bypassing a gas is being used as another mechanism of the conventional art. However, this method is disadvantageous in that the capacity cannot be varied variously.

### SUMMARY OF THE INVENTION

Therefore, an object of the present invention is to provide a scroll compressor to improve compression performance while maintaining the size of the compressor and to improve efficiency of the compressor by varying a compression capacity and thusly allowing the optimum operation according to external conditions.

To achieve these and other advantages and in accordance with the purpose of the present invention, as embodied and broadly described herein, there is provided an orbiting scroll compressor comprising: a frame fixed in a casing; a driving motor fixed in the casing and supplying a driving force; a fixed scroll fixed in the casing; an orbiting scroll forming a first compression space as its one side is interlocked with the fixed scroll, and orbiting by being eccentrically coupled to a driving shaft connected to the driving motor; an orbiting vane protruding from the other side of the orbiting scroll to a predetermined height and forming a second compression space with a vane receiving groove of the frame; a capacity varying unit communicating with the second compression space and varying its capacity; and a control unit connected to the capacity varying unit and controlling the capacity varying unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a longitudinal sectional view which illustrates part of the conventional scroll compressor;

FIG. 2 is a block diagram of a freezing cycle system including a scroll compressor in accordance with the present invention;

FIG. 3 is a longitudinal sectional view which illustrates one example of the scroll compressor in accordance with the present invention;

FIG. 4 is a plan view which illustrates a capacity varying apparatus for a vane compression unit of the scroll compressor in accordance with the present invention;

FIG. 5 is an exploded plan view which illustrates the capacity varying apparatus of the scroll compressor in accordance with the present invention;

FIGS. 6A to 6D are schematic views showing the compression principle of the scroll compressor in accordance with the present invention;

FIGS. 7A and 7B are schematic views of the operation of the capacity varying apparatus of the scroll compressor in accordance with the present invention;

FIG. 8 is a longitudinal sectional view which illustrates a modified example of the scroll compressor in accordance with the present invention;

FIG. 9 is a plan view which illustrates a modified example of the capacity varying apparatus for the vane compression unit of the scroll compressor in accordance with the present invention; and

FIGS. 10A to 10C are schematic views which illustrate the operation of the modified capacity varying apparatus of the scroll compressor in accordance with the present invention.

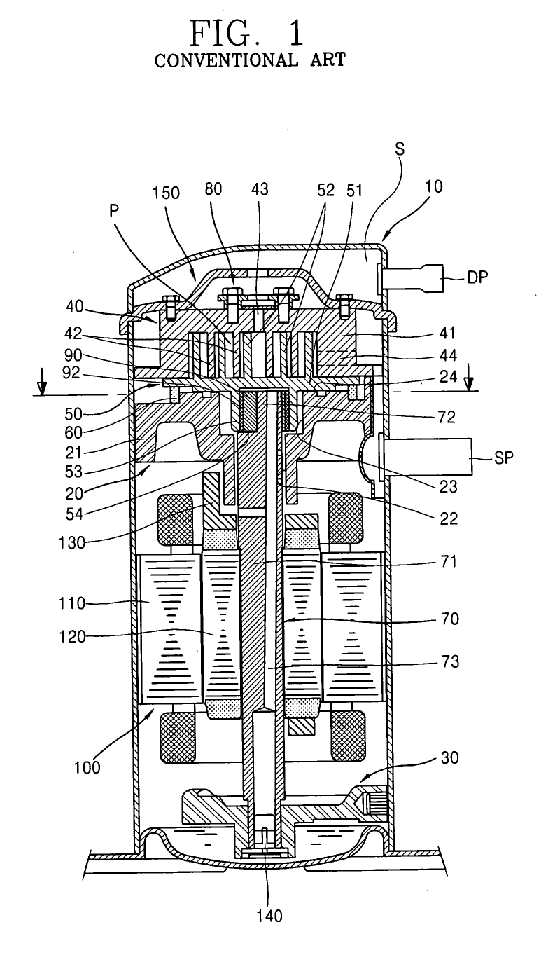

### DETAILED DESCRIPTION OF THE PREFERRED EMBODIMENTS

Reference will now be made in detail to the preferred embodiments of the present invention, examples of which are illustrated in the accompanying drawings.

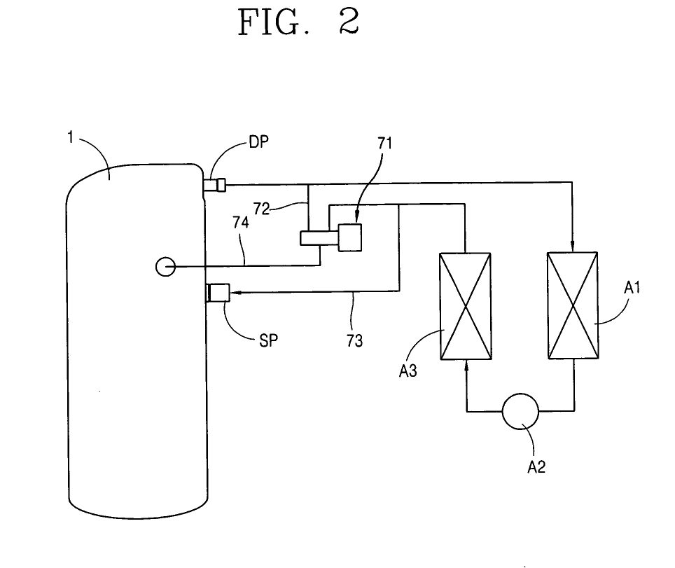

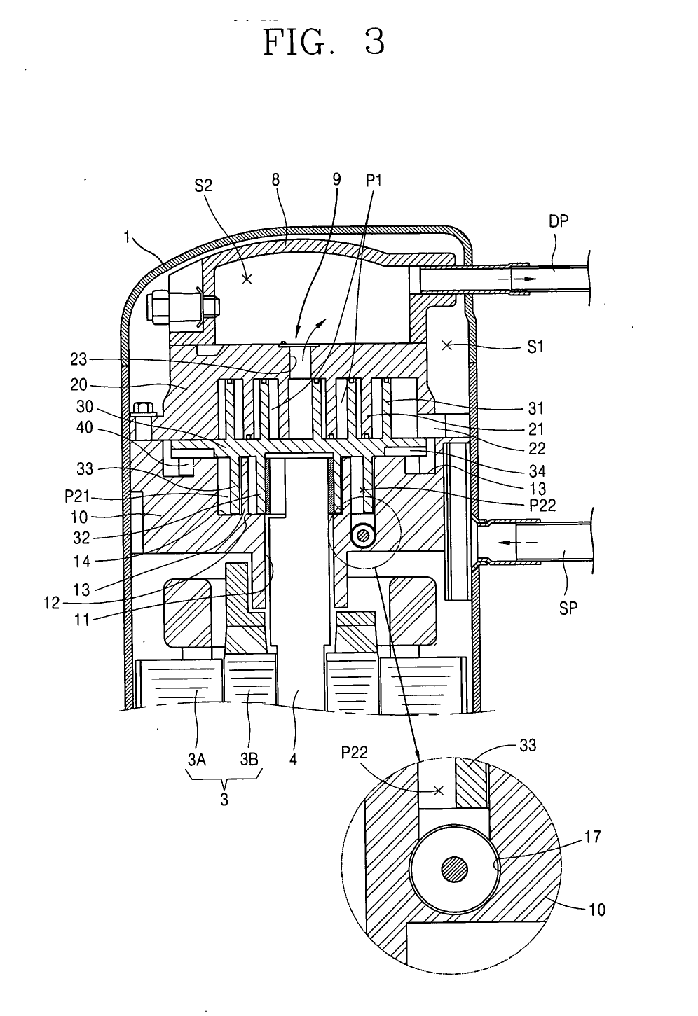

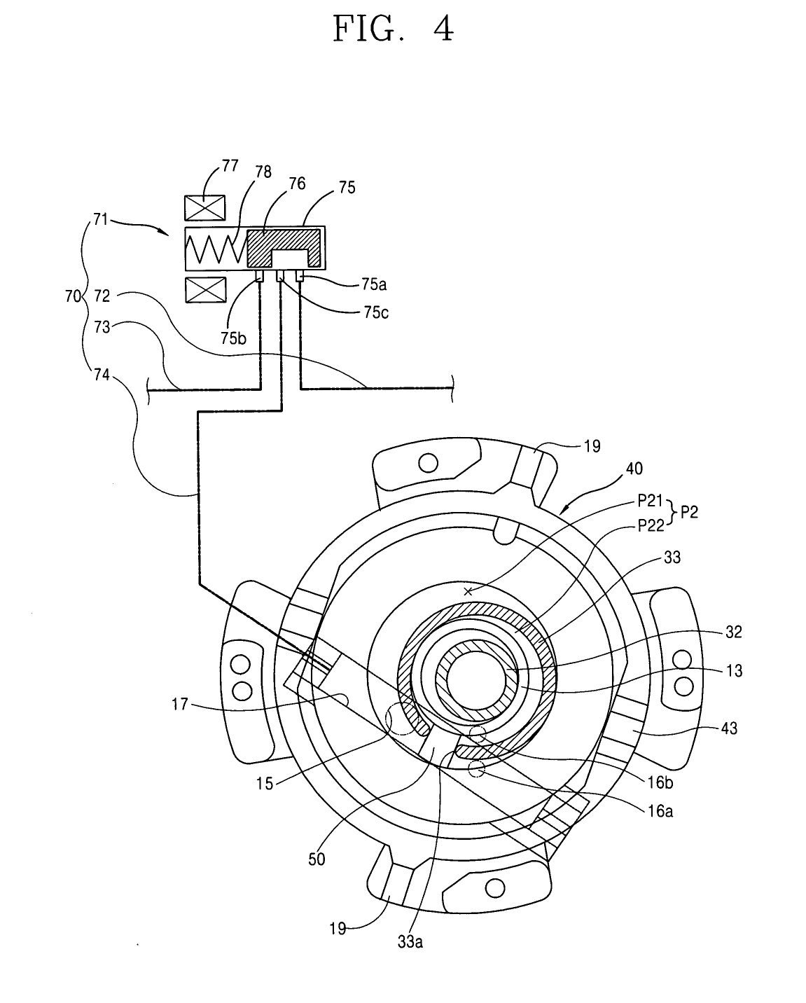

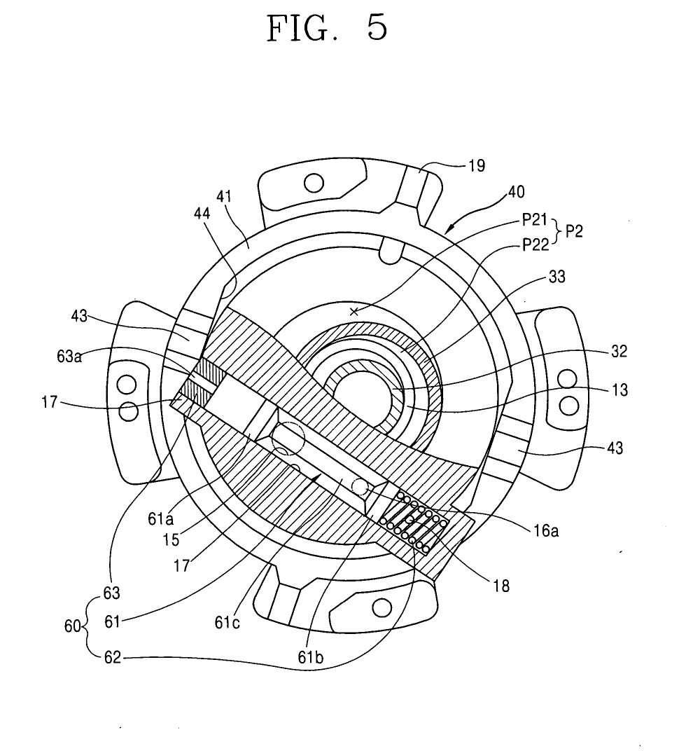

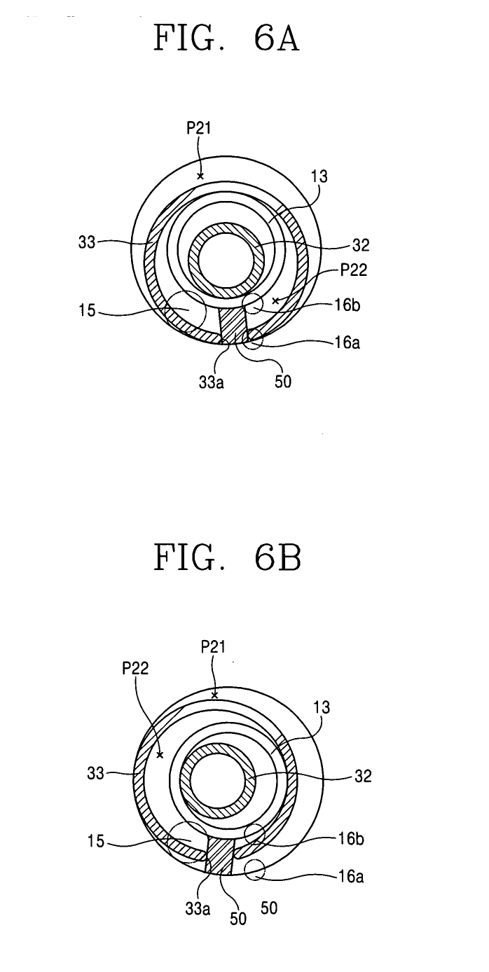

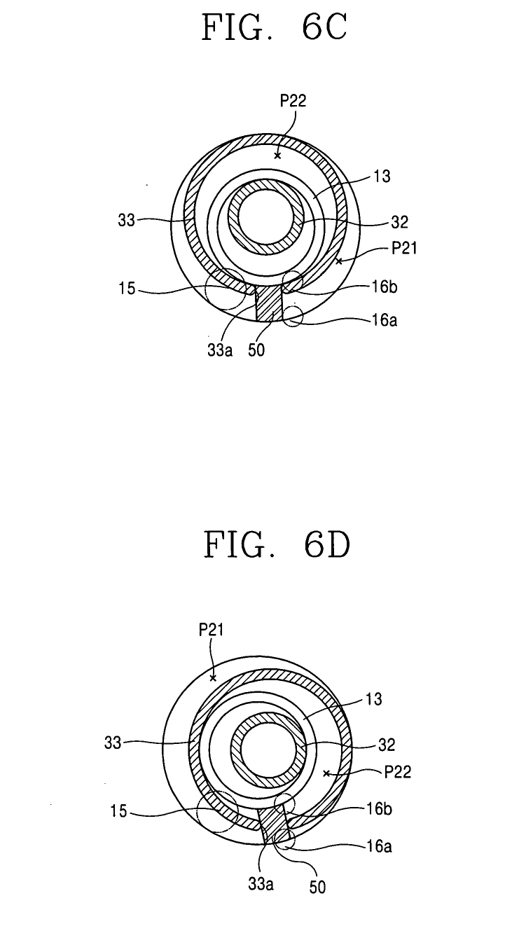

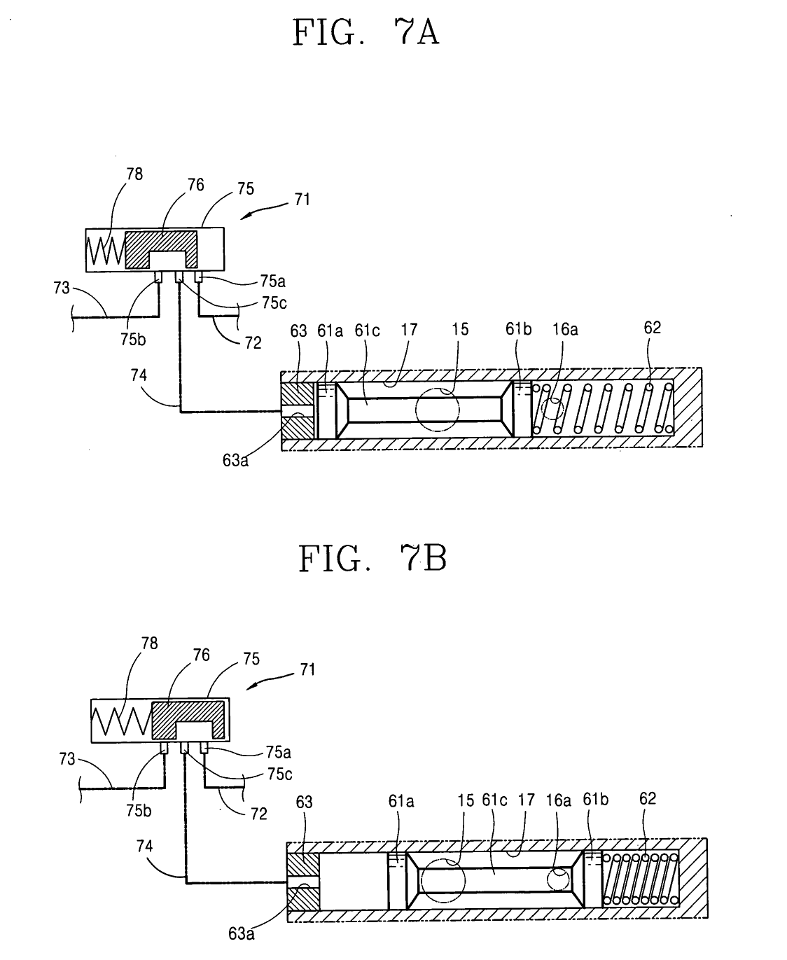

FIG. 2 is a block diagram of a freezing cycle system including a scroll compressor in accordance with the present invention, FIG. 3 is a longitudinal sectional view which illustrates one example of the scroll compressor in accordance with the present invention, FIG. 4 is a plan view which illustrates a capacity varying apparatus for a vane compression unit of the scroll compressor in accordance with the present invention, FIG. 5 is an exploded plan view which illustrates the capacity varying apparatus of the scroll compressor in accordance with the present invention, FIG. 6 is a schematic view for describing a compression principle of the scroll compressor in accordance with the present invention, and FIGS. 7A and 7B are schematic views of the operation of the capacity varying apparatus of the scroll compressor in accordance with the present invention.

As shown, the scroll compressor in accordance with the present invention includes a casing 1 provided with a gas intake pipe (SP) and a gas discharge pipe (DP), a main frame 10 and a sub-frame (not shown) respectively fixed to upper and lower sides of an inner circumferential surface of the casing 1, a driving motor 3 mounted between the main frame 10 and the sub-frame (not shown), a driving shaft 4 pressingly inserted in the center of the driving motor 3, penetrating the main frame 10 and transferring a rotary force of the driving motor 3, a fixed scroll 20 fixedly installed at an upper surface of the main frame 10, an orbiting scroll 30 placed on the main frame 10 and interlocked with the fixed scroll 20 to orbit, so that two scroll type compression pockets (hereinafter, referred to as “first compression pockets”) are formed as a pair, an oldham ring 40 installed between the orbiting scroll 30 and the main frame 10 and preventing rotation of the orbiting scroll 30 to allow the orbiting of the orbiting scroll 30, a sliding block 50 coupled to a rear side of the orbiting scroll 30, sliding in a radial direction and forming a plurality of vane type compression pockets (hereinafter, referred to as “second compression pockets”) P21 and P22 between a vane receiving groove 14 of the main frame 10 and an orbiting vane 33 of the orbiting scroll 30 which are to be described later, a discharge cover 8 coupled to a rear side of the fixed scroll 20 and dividing the inside of the casing 1 into an intake space S1 and a discharge space (S2), a capacity varying unit 60 (FIG. 5) provided at the main frame and varying the capacity of the second compression pockets, and a control unit 70 connected to the capacity varying unit 60 and operating the capacity varying unit 60 by a pressure difference according to an operation mode of the compressor.

As shown in FIGS. 3 to 5, a shaft hole 11 supporting the driving shaft 4 in a radial direction is formed at the center of the main frame 10, and a boss receiving groove 12 is extendingly formed at an upper portion of the shaft hole 11 to allow an orbiting movement of a boss portion 32 of the orbiting scroll 30. Also, a vane receiving groove 14 is formed outside the boss receiving groove 12 and forms the second compression pocket P2 such that orbiting vanes 33 to be described later are inserted therein, having therebetween a partition wall 13 of a predetermined thickness. Also, a vane-side intake hole 15 and a plurality of vane-side discharge holes 16a and 16b are formed on a bottom surface of the vane receiving groove 14, having the sliding block 50 therebetween. On the basis of the sliding block 50, the vane-side intake hole 15 is formed at one side of a circumferential direction and, at the other side thereof, the plurality of vane-side discharge holes 16a are formed outside and inside the orbiting vane 33 to be described later, respectively. The middle portion of the vane-side intake hole 15 and the middle portion of the vane-side discharge hole 16a communicate with each other, and such communication therebetween is allowed or blocked by a sliding valve 61 to be described later, which is formed within a bypass hole 17. Here, the vane receiving groove 14 may have the same depth as that of the boss receiving groove 12. However, as occasion demands, the boss receiving groove 12 may have the greater depth to form an oil discharge hole in a radial direction.

As shown in FIG. 5, the compression pocket can be divided into an outer vane type compression pocket (outer pocket) P21 and an inner vane type compression pocket (inner pocket) P22 by the orbiting vane 33, and a vane-side intake hole 15 is formed to have an area that allows communication with the outer pocket P21 or the inner pocket P22 or both during operation. Also, vane-side discharge holes 16a, 16b are preferably formed apart from each other with a spaced interval between each discharge hole 16a, 16b, whereby each discharge hole 16a, 16b is formed to have an area that allows communication with the outer pocket P21 and the inner pocket P22, respectively. Also, the vane-side intake hole 15 and the vane-side discharge holes 16a and 16b penetrate the inside of the main frame 10, wherein, preferably, the vane-side intake hole 15 communicates with the intake space S1 of the casing 1 and the vane-side discharge holes 16a and 16b communicate with the discharge space S2 of the discharge cover 8 through the main frame 1 and the fixed scroll 20. Here, discharge valves (not shown) are installed at outlet ends of the vane-side discharge holes 16a and 16b in order to control the discharge operation of a refrigerant gas from both compression pockets P21 and P22.

The bypass hole 17 is formed to a predetermined depth to perpendicularly penetrate the vane-side intake hole 15 and the vane-side discharge hole 16a from an outer circumferential surface of the main frame 10, and its opened one side is sealed by a valve stopper 63 pressingly inserted thereinto and having a back pressure through hole 63a and. A uniform hole 18 is formed at a circumferential surface of a space where a valve spring 62 to be described later is installed so as to communicate with the intake space S1.

The fixed scroll 20 includes a wrap 21 having an involute shape and forming a pair of first compression pockets P1 by being interlocked with a wrap 31 of the orbiting scroll 30. Also, the fixed scroll 20 includes a scroll-side intake hole 22 formed outside the outermost wrap, and a scroll-side discharge hole 23 formed at the center portion of the fixed scroll 20 and communicating with the discharge space S2 of the casing 1.

As shown in FIGS. 3 and 4, the orbiting scroll 30 includes a wrap 31 having an involute shape and interlocked with the wrap 21 of the fixed scroll 20, a boss portion 32 formed at the center of a lower surface of the circular plate, coupled to an eccentric portion of the driving shaft 4 and orbiting within the boss receiving pocket 12 of the main frame 10, and an annular orbiting vane 33 formed outside the boss portion 32 at a predetermined interval therebetween such that, when the orbiting scroll 30 orbits, its outer circumferential surface comes in line-contact with an inner circumferential surface of the boss receiving groove 12 and its inner circumferential surface comes in line-contact with an outer circumferential surface of the partition wall 13 of the main frame 10. A block slit 33a is formed at one side of a circumferential surface of the orbiting vane 33, namely between the vane-side intake hole 15 and two vane-side discharge holes 16a and 16b so that the sliding block 50 can slide in a radial direction.

As shown in FIG. 4, as for the sliding block 50, its outer circumferential surface is formed as a circular arc shape so as to slidingly contact with an outer circumferential surface of the vane receiving groove 14 of the main frame 10, and its inner circumferential surface is formed as a circular arc shape so as to slidingly contact with an outer circumferential surface of the partition wall 13 of the main frame 10, which constitutes an inner circumferential surface of the vane receiving groove 14. Such a construction of the sliding block 50 is preferable to prevent a leakage of a refrigerant gas.

As shown in FIG. 5, the capacity varying unit 60 includes a sliding valve 61, slidingly inserted in the bypass hole 17, that opens and closes the vane-side intake hole 15 and the vane-side discharge hole 16a by moving within the bypass hole 17 according to a pressure difference due to the control unit 70, at least one valve spring 62 including a compression spring elastically supporting a moving direction of the sliding valve 61 so as to move the sliding valve 61 to a position where the sliding valve 61 is closed when there is no pressure difference between both ends, and a valve stopper 63 shielding an opened end of one side of the bypass hole 17 so as to prevent escape of the sliding valve 61.

The sliding valve 61 includes a first pressure portion 61a slidingly coming in contact with an inner circumferential surface of the bypass hole 17 and receiving pressure from the control unit 70, a second pressure portion 61b slidingly coming in contact with a circumferential surface of the bypass hole 17, supported by the valve spring 62 and allowing and blocking communication between the vane-side intake hole 15 and the vane-side discharge hole 16a, and a communication portion 61c connecting the two pressure portions 61a and 61b and forming a gas path between its outer circumferential surface and the bypass hole 17. Preferably, for the purpose of minimizing a length of the valve, the second pressure portion 61b have a smaller diameter than diameters of the vane-side intake hole 15 and the vane-side discharge hole 16a and a spring fixing groove (not shown) in which the valve spring 62 is inserted to be fixed is formed at the inside of a rear end of the second pressure portion 61b.

As described above, the valve spring 62 may be installed at a rear surface of the second pressure portion 61b that allows or blocks communication between the vane-side intake hole 15 and the vane-side discharge hole 16a. However, as occasion demands, the valve spring 62 may be installed at a rear surface of the first pressure part 61a, and a common connection pipe 74 of the control unit 70 to be described later may be installed at the rear surface of the second pressure portion 61b to communicate therewith.

A back pressure through hole 63a is formed at the center of the valve stopper 63 and is connected to the common connection pipe 74 of the control unit 70 to be described later.

As shown in FIGS. 4 and 5, the control unit 70 includes a switching valve assembly 71 determining pressure of the pressure portion side of the sliding valve 61, a high pressure connection pipe 72 connected between the gas discharge pipe (DP) and a high pressure side inlet 75a of the switching valve assembly 71 and supplying a high pressure atmosphere, a low pressure connection pipe 73 connected between the gas intake pipe (SP) and a low pressure side inlet 75b of the switching valve assembly 71 and supplying a low pressure atmosphere, and a common connection pipe 74 connecting a common side outlet 75c of the switching valve assembly 71 to the back pressure through hole 63a of the valve stopper 63 and selectively supplying the high pressure atmosphere or the low pressure atmosphere to the first pressure portion 61a of the sliding valve 61.

The switching valve assembly 71 includes a switching valve housing 75 having the high pressure side inlet 75a, the low pressure side inlet 75b and the common side outlet 75c, a switching valve 76 slidingly coupled to the inside of the switching valve housing 75 to selectively connect the high pressure side inlet 75a to the common side outlet 75c or the low pressure side inlet 75b to the common side outlet 75c, an electromagnet installed at one side of the switching valve housing 75 and moving the switching valve 76 by applied power, and a switching valve spring 78 returning the switching valve 76 to an initial position when the power applied to the electromagnet 77 is cut off.

On the drawing, undescribed reference mark A1 is a condenser, A2 is a expansion mechanism, A3 is an evaporator, 3A is a stator, 19 is a key groove, and 41, 43 and 44 are a body portion, an upper key portion and a sliding surface of the oldham ring, respectively.

The same reference marks are designated to the same parts as those of the conventional art.

The capacity varying apparatus of the scroll compressor in accordance with the present invention has the following operational effect.

As shown in FIG. 3, as the driving shaft 4 is rotated together with a rotor 3B of the driving motor 3 by applied power, the orbiting scroll 30 orbits as long as an eccentric distance to thereby form a pair of first compression pockets P1 between the wrap 31 of the orbiting scroll 30 and the wrap 21 of the fixed scroll 20. The first compression pockets P1 continuously move toward the center by the continuous orbiting of the orbiting scroll 30, contracting the volumes. In such a process, a refrigerant gas is received in the first compression pockets P1 through the scroll-side intake hole 22 from the intake space S1 of the casing 1, is gradually compressed, and then is discharged to the discharge space S2 of the casing 1 through the scroll-side discharge hole 23 of the fixed scroll 20.

Also, as shown in FIGS. 4 and 5, because the orbiting vane 33 is formed at a rear surface of the orbiting scroll 30 and the sliding block 50 linearly moving in a radial direction is provided at the orbiting vane 33 between the vane-side intake hole 15 and each vane-side discharge hole 16a, 16b, when the orbiting scroll orbits 30, an outer pocket P21 and an inner pocket P22 are formed with a phase difference of 180° therebetween by the sliding block between an outer circumferential surface of the orbiting vane 33 of the orbiting scroll 30 and an inner circumferential surface of the boss receiving groove 12 of the main frame 10 and between an inner circumferential surface of the orbiting vane 33 and an outer circumferential surface of the partition wall 13 of the main frame 10, respectively. Thus, the refrigerant gas within the casing 1 is received alternately in the outer pocket (P21) and the inner pocket (P22) through the vane-side intake hole 15, is compressed therein, and then is discharged through both vane-side discharge holes 16a and 16b. The discharged gas is discharged to the discharge space (S2) of the casing through a gas guiding pipe (not shown) or a gas through hole (not shown), and is discharged to the gas discharge pipe (DP) of the casing 1 together with the compressed gas discharged from the first compression pocket (P1).

Here, the process in which a refrigerant is received and compressed in the second compression pocket will now be described in more detail.

For example, as shown in FIG. 6A, when the block slit 33a of the orbiting vane 33 aligns with the outer circumferential surface of the sliding block 50 while contacting with the inner circumferential surface of the vane receiving groove 14 of the main frame 10, if this situation is assumed to be 0 degrees, the intake hole 15 is only in communication with the inner pocket P22 at one side of the sliding block 50 to allow intake of a refrigerant therethrough, while simultaneously, at the other side of the sliding block 50, the discharge operation begins. Meanwhile, at the outer pocket P21, intake is completed and the compression operation begins.

Then, as shown in FIG. 6B, when the orbiting vane 33 reaches a position of 90 degrees by orbiting further, the intake of a refrigerant is finely performed through the outer pocket P21 at one side of the sliding block 50, while simultaneously, at the other side of the sliding block 50, the compression is further performed therethrough. Meanwhile, in the inner pocket (P22), as an intake area gets greater, the intake of the refrigerant is performed at its one side, while simultaneously, at the other side thereof, the compression is terminated.

Then, as shown in FIG. 6C, when the orbiting vane 33 reaches a position of 180 degrees by orbiting further, the intake is performed at one side of the outer pocket P21, while simultaneously, at the other side of the outer pocket P21, the discharge begins. Meanwhile, at the inner pocket P22, the intake is completed and the compression operation begins.

Then, as shown in FIG. 6D, when the orbiting vane 33 reaches a position of 270 degrees by orbiting further, the intake of the refrigerant is continuously performed at one side of the outer pocket P21, while simultaneously, at the other side of the outer pocket P21, the compression is completed. Also, the intake begins at one side of the inner pocket P22 and the compression continues at the other side thereof. Then, the stroke described through FIGS. 6A through 6D is repetitively performed.

The scroll compressor using a vane type compression method is operated in a high capacity mode or a low capacity mode according to an operation state of an air conditioner employing such a compressor, and this will now be described in more detail.

First, as shown in FIG. 7A, in the high-capacity operation mode, as power is applied to the electromagnet 77 of the control unit 70 which is a a pilot valve, the switching valve 76 overcomes an elastic force of the switching valve spring 78 and moves to allow communication between the low pressure side outlet 75b and the common side outlet 75c. Then, a low pressure refrigerant gas having passed through the gas intake pipe (SP) or the evaporator (A3) is introduced toward the first compression portion 61a of the sliding valve 61 via the low pressure connection pipe 73 and the common connection pipe 74. Here, the sliding valve 61 is pushed by the elastic force of the valve spring 62 supporting the second pressure portion 61 and is thusly moved to the right side of the drawing, so that the second pressure portion 61b is placed between the vane-side intake hole 15 and the vane-side discharge hole 16. In such a manner, the refrigerant gas having received in the outer pocket (P21) and the inner pocket (P22) is completely compressed, then, is discharged to the discharge space (S2) of the discharge cover 8, and circulates through the condenser (A1), the expanding mechanism (A2) and the evaporator (A3), thereby performing a compression operation that exhibits approximately 100% cooling capability.

In contrast, as shown in FIG. 7B, in the low-capacity operation, as power is not applied to the electromagnet 77 of the control unit 70 which is a pilot valve, the switching valve 76 is moved by the elastic force of the switching valve spring 78 to thereby allow communication between the high pressure outlet 75a and the common side outlet 75c. Thus, a high pressure refrigerant gas within the gas discharge pipe (DP) or the casing 1 is introduced toward the first pressure portion 61a of the sliding valve 61 via the high pressure connection pipe 72 and the common connection pipe 74. Here, the sliding valve 61 overcomes an elastic force of the valve spring 62 by the high pressure atmosphere formed at a pressure surface of the first pressure portion 61a, and is moved to the right side of the drawing, so that the communication portion 61c of the sliding valve 61 is placed between the vane-side intake hole 15 and the vane-side discharge hole 16, allowing communication between the intake hole 15 and the discharge hole 15a. In such a manner, a refrigerant gas having received in the outer pocket (P21) of the second compression pocket (P2) is leaked to the vane-side intake hole 15 through the vane-side discharge hole 16a and the bypass hole 17. For this reason, the compression does not occur in the outer pocket (P21) of the second compression pocket (P2) but occurs only in the inner pocket (P22) of the second compression pocket (P2).

Here, if the valve spring of the capacity varying unit is installed at a rear surface of the first pressure portion of the sliding valve, the control unit moves the sliding valve in an opposite manner to that described above to achieve the high-capacity operation and the low-capacity operation. Because the operation of the capacity varying unit is the same as that of the aforementioned one, the detailed description thereon will be omitted.

As the scroll compressor includes a vane compression part besides a scroll compression part, the capacity thereof can be greatly improved without increasing the size of the compressor. Also, because the capacity of the vane compression part is varied into two levels, the capacity varying performance of the scroll compressor can be improved.

Also, the scroll compressor in accordance with the present invention may be operated not only in the high-capacity operation mode and the low-capacity operation mode but also in a medium-capacity operation mode. In such a case, preferably, the capacity of an outer pocket of the second compression pocket is different from the capacity of an inner pocket. The case where the capacity of the outer pocket is set to 60% and the capacity of the inner pocket is set to 40% will now be described as an example.

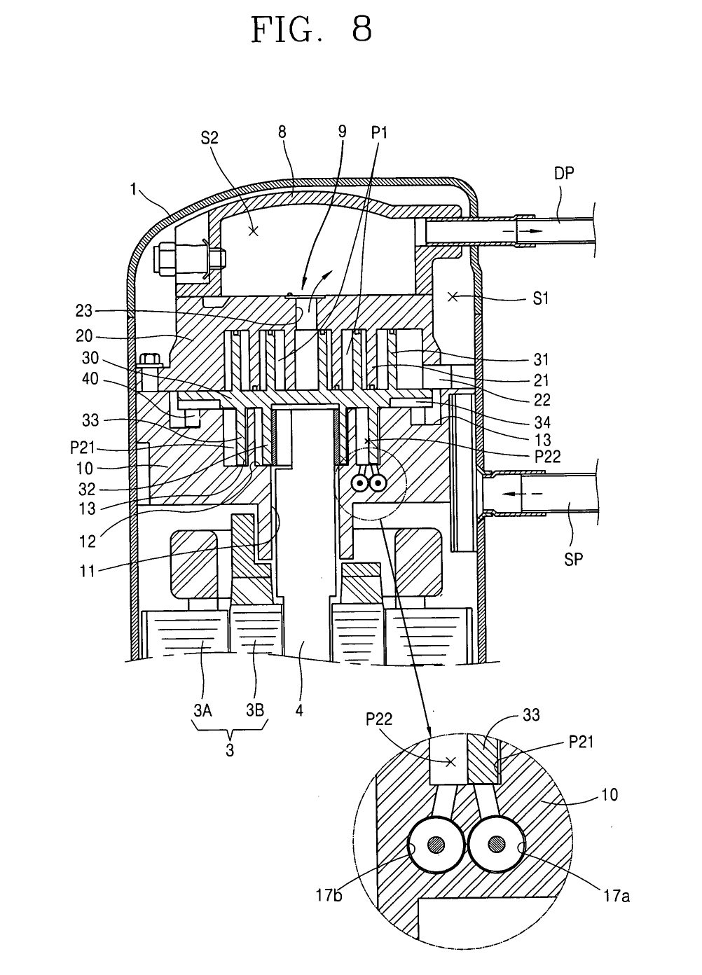

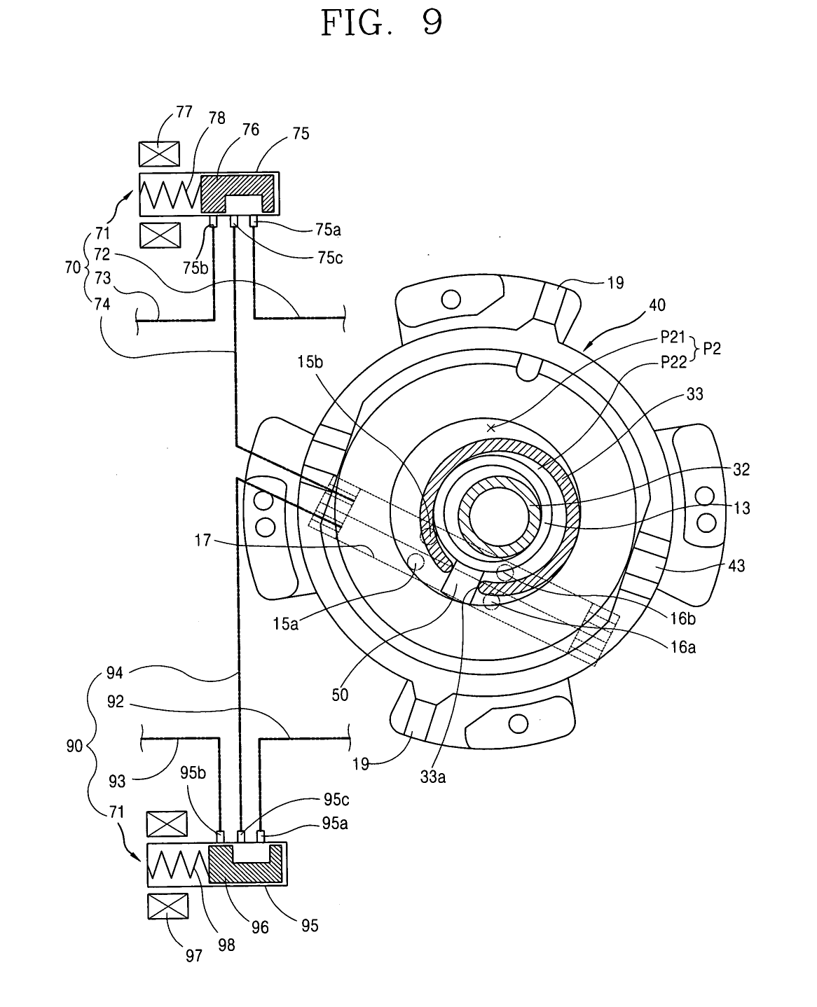

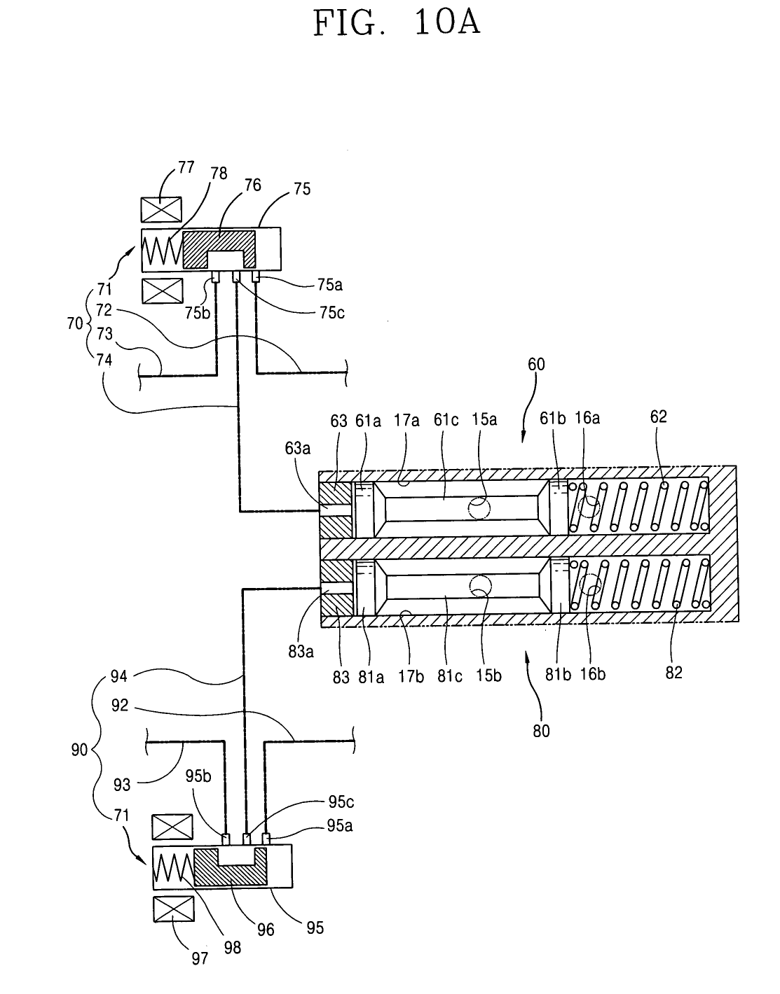

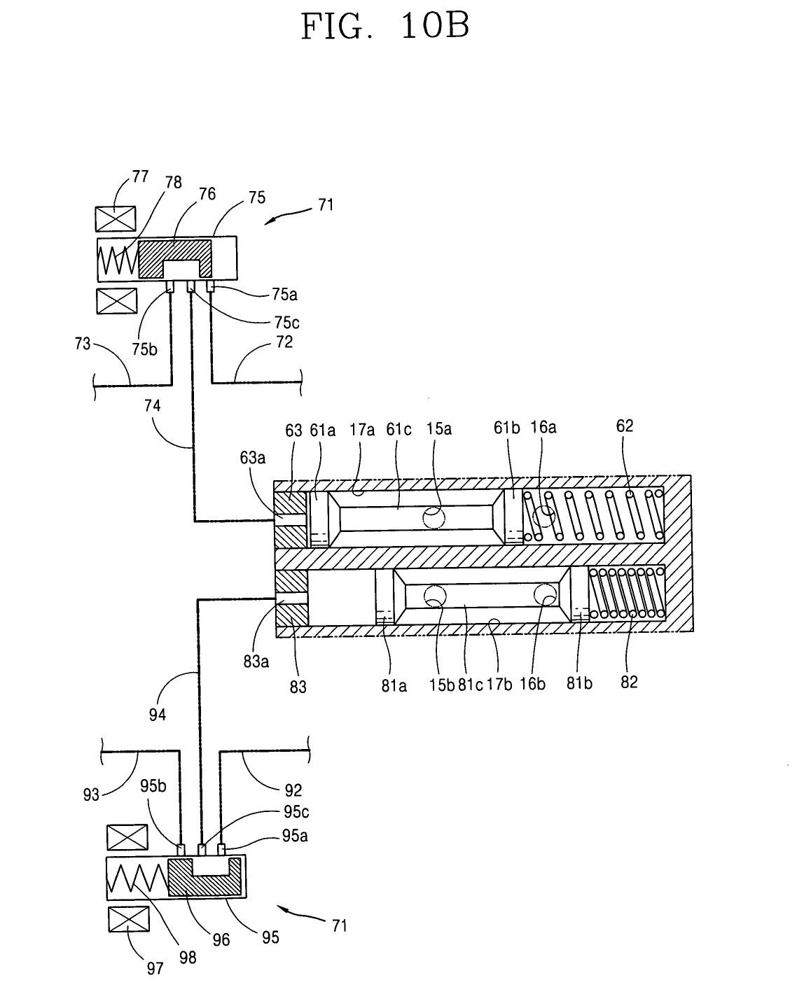

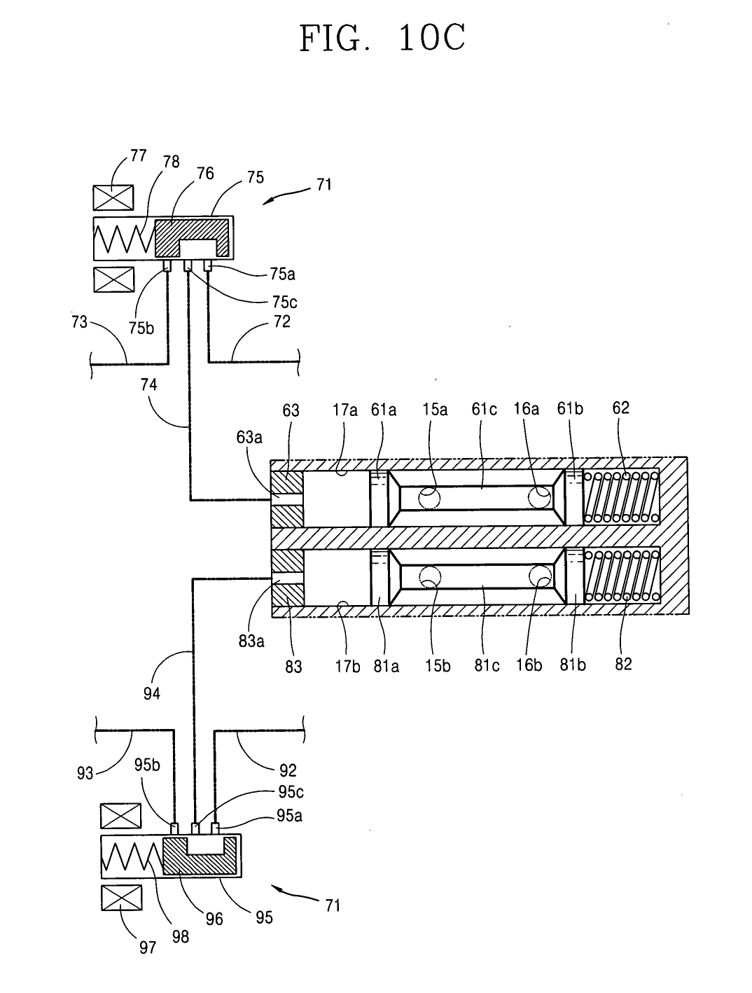

FIG. 8 is a longitudinal sectional view which illustrates a modified example of the scroll compressor in accordance with the present invention, FIG. 9 is a plan view which illustrates a modified example of the capacity varying apparatus for the vane compression unit of the scroll compressor in accordance with the present invention, and FIGS. 10A to 10C are schematic views which illustrate the operation of the modified capacity varying apparatus of the scroll compressor in accordance with the present invention.

As shown, the vane compression part of the scroll compressor in accordance with the present invention includes: a main frame 10 including a first vane-side intake hole 15a and a first vane-side discharge hole 16a that are in communication with the aforementioned outer pocket (P21), a second vane-side intake hole 15b and a second vane-side discharge hole that are in communication with the inner pocket (P22), a first bypass hole 17a formed to allow communication between the first vane-side intake hole 15a and the first vane discharge hole 16a, and a second bypass hole 17b formed to allow communication between the second vane-side intake hole 15b and the second vane discharge hole 16b; a first capacity varying unit 60 for varying a capacity of the outer pocket (P21) by opening or closing the first bypass hole 17a of the main frame 10; a first control unit 70 for driving the first capacity varying unit 60; a second capacity varying unit 80 for varying a capacity of the inner pocket (P22) by opening or closing the second bypass hole 17b of the main frame 10; and a second control unit 90 for driving the second capacity varying unit 80.

Because the first capacity varying unit 60, the second capacity varying unit 80, the first control unit 70 and the second control unit 90 are the same as those that were described in one example with reference to FIGS. 4 and 5, the detailed description thereon will be omitted.

The same reference numerals are designated to the same parts as those that were described in one example.

Undescribed reference numerals 61 and 81 are first and second sliding valves, 61a and 81a are first pressure portions of sliding valves, 61b and 81b are second pressure portions of the sliding valves, 61c and 81c are communication portions of the sliding valves, 62 and 82 are first and second valve springs, 63 and 83 are first and second valve stoppers, 71 and 91 are first and second switching valve assemblies, 72 and 92 are first and second high-pressure connection pipes, 73 and 93 are first and second low-pressure connection pipes, 74 and 94 are first and second common connection pipes, 75 and 95 are first and second switching valve housings, 76 and 96 are first and second switching valves, 77 and 97 are first and second electromagnets, and 78 and 98 are first and second switching valve springs.

The scroll compressor in accordance with the present invention have the following operational effect.

First, in the high-capacity operation mode, as shown in FIG. 10A, by the first control unit 70 and the second control unit 90, the second pressure portions 61b and 81b of the sliding valves 61 and 81 block communication between the vane-side intake holes 15a and 15b and the vane-side discharge holes 16a and 16b, respectively. Thusly, a refrigerant having received in the outer pocket (P21) and the inner pocket (P22) of the second compression pocket (P2) is completely compressed and discharged, so that the vane compression part of the scroll compressor exhibits 100% cooling capability.

Then, in the medium-capacity operation mode, as shown in FIG. 10B, by the first control unit 60, the second pressure portion 61b of the first sliding valve 61 blocks the communication between the first vane-side intake hole 15a and the first vane-side discharge hole 16a, so that the refrigerant having received in the outer pocket (P21) is completely compressed and discharged. Meanwhile, by the second control unit 70, the communication portion 81c of the second sliding valve 81 is placed between the second vane-side intake hole 15b and the second vane-side discharge hole 16b, so that a refrigerant having received in the inner pocket (P22) is not compressed but leaked. Thus, the vane compression part of the scroll compressor exhibits only 60% cooling capability which is same as the capacity of the outer pocket (P21).

Then, in the low-capacity operation mode, as shown in FIG. 10C, by the first control unit 71, the communication portion 61c of the first sliding valve 61 is placed between the first vane-side intake hole 15a and the first vane-side discharge hole 16a, so that the refrigerant having received in the outer pocket (P21) is not compressed but leaked. Meanwhile, by the second control unit 90, the second pressure portion 81b of the second sliding valve 81 blocks the communication between the second vane-side intake hole 15b and the second vane-side discharge hole 16b, so that the refrigerant having received in the inner pocket (P22) is completely compressed and discharged. Thus, the vane compression part of the scroll compressor exhibits 40% cooling capability which is the same as the capacity of the inner pocket (P22).

In such a manner, by varying the capacity of the vane compression part into three levels, the capacity varying performance of the scroll compressor can be more improved.

As described so far, because the scroll compressor in accordance with the present invention includes a vane compression part besides a scroll compression part, the capacity of the compressor can be greatly increased without increasing the size of the compressor. Also, because the capacity of the vane compression part is varied into multiple levels, the capacity varying performance of the scroll compressor is improved and the performance of the compressor itself is thusly greatly improved.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An orbiting scroll compressor comprising:
a frame fixed in a casing;
a driving motor fixed in the casing and supplying a driving force;
a fixed scroll fixed in the casing;
an orbiting scroll forming a first compression space as its one side is interlocked with the fixed scroll, and orbiting by being eccentrically coupled to a driving shaft connected to the driving motor;
an orbiting vane protruding from the other side of the orbiting scroll to a predetermined height and forming a second compression space with a vane receiving groove of the frame;
a capacity varying unit communicating with the second compression space and varying its capacity; and
a control unit connected to the capacity varying unit and controlling the capacity varying unit.

2. The scroll compressor of claim 1, wherein the orbiting scroll includes a boss portion formed at a rear surface contacting with the frame and eccentrically coupled with the driving shaft, the orbiting scroll having the orbiting vane integrally formed outside the boss portion, and
the frame includes a boss receiving groove formed at a central portion of an upper surface on which the orbiting scroll and coupled to the orbiting scroll to allow orbiting of the orbiting scroll, and a vane receiving groove formed outside the boss receiving groove and coupled to the orbiting vane of the orbiting scroll to allow the orbiting of the orbiting scroll and thusly form a vane type compression pocket.

3. The scroll compressor of claim 2, wherein a plurality of vane discharge holes are independently provided outside and inside the orbiting vane to thereby form a plurality of vane type compression pockets.

4. The scroll compressor of claim 3, wherein one vane-side intake hole is formed on a bottom surface of the vane receiving groove to communicate with the plurality of vane type compression pockets formed inside and outside the orbiting vane, and one bypass hole is formed to connect a middle portion of the vane-side intake hole with a middle portion of one of the vane-side discharge holes and is opened and closed by the capacity varying unit.

5. The scroll compressor of claim 3, wherein a plurality of vane-side intake holes are formed on a bottom surface of the vane receiving groove to independently communicate with the plurality of vane type compression pockets formed inside and outside the orbiting vane, and a plurality of bypass holes are formed to independently connect middle portions of the vane-side intake holes with middle portions of the vane-side discharge holes and are independently opened and closed by the capacity varying unit.

6. The scroll compressor of claim 4, wherein the plurality of vane type compression pockets formed inside and outside the orbiting vane have the same capacity.

7. The scroll compressor of claim 5, wherein the plurality of vane type compression pockets formed inside and outside the orbiting vane have the same capacity.

8. The scroll compressor of claim 4, wherein the plurality of vane type compression pockets formed inside and outside the orbiting vane have different capacities.

9. The scroll compressor of claim 5, wherein the plurality of vane type compression pockets formed inside and outside the orbiting vane have different capacities.

10. The scroll compressor of claim 4, wherein the capacity varying unit includes a sliding valve slidingly inserted in the bypass hole and opening and closing the vane-side intake hole and the vane-side discharge hole by moving by a pressure difference due to the control unit, and at least one valve spring elastically supporting a moving direction of the sliding valve and moving the sliding valve to its close position when there is no pressure difference between both ends.

11. The scroll compressor of claim 5, wherein the capacity varying unit includes a sliding valve slidingly inserted in the bypass hole and opening and closing the vane-side intake hole and the vane-side discharge hole by moving by a pressure difference due to the control unit, and at least one valve spring elastically supporting a moving direction of the sliding valve and moving the sliding valve to its closed position when there is no pressure difference between both ends.

12. The scroll compressor of claim 10, wherein the sliding valve includes a plurality of pressure portions placed at both sides of the bypass hole and slidingly contacting with an inner circumferential surface of the bypass hole, wherein at least one pressure portion can allow and block communication between the vane-side intake hole and the vane-side discharge hole by moving upon receiving pressure through the control unit, and a communication portion connecting the plurality of pressure portions and having a gas path between its outer circumferential surface and the bypass hole to allow the vane-side intake hole and the vane-side discharge hole to communicate with each other.

13. The scroll compressor of claim 11, wherein the sliding valve includes a plurality of pressure portions placed at both sides of the bypass hole and slidingly contacting with an inner circumferential surface of the bypass hole, wherein at least one pressure portion can allow and block communication between the vane-side intake hole and the vane-side discharge hole by moving upon receiving pressure through the control unit, and a communication portion connecting the plurality of pressure portions and having a gas path between its outer circumferential surface and the bypass hole to allow the vane-side intake hole and the vane-side discharge hole to communicate with each other.

14. The scroll compressor of claim 12, wherein the bypass hole includes at at least one of both sides, a back pressure through hole communicating with an outlet of the control unit.

15. The scroll compressor of claim 13, wherein the bypass hole includes at at least one of both sides, a back pressure through hole communicating with an outlet of the control unit.

16. The scroll compressor of claim 14, wherein the valve spring is installed at a rear surface of a pressure portion close to the vane-side discharge hole of the sliding valve.

17. The scroll compressor of claim 15, wherein the valve spring is installed at a rear surface of a pressure portion close to the vane-side discharge hole of the sliding valve.

18. The scroll compressor of claim 15, wherein the valve spring is installed at a rear surface of a pressure portion close to the vane-side intake hole of the sliding valve.

19. The scroll compressor of claim 4, wherein the control unit includes a switching valve assembly determining pressure of a pressure portion side of the sliding valve, a high pressure connection pipe connected to a high pressure side inlet of the switching valve assembly and providing a high-pressure atmosphere, a low-pressure connection pipe connected to a low pressure side inlet of the switching valve assembly and providing a low-pressure atmosphere, and a common connection pipe connecting a common side outlet of the switching valve assembly to the bypass hole and providing a high-pressure atmosphere or a low-pressure atmosphere to a pressure portion of the sliding valve.

20. The scroll compressor of claim 5, wherein the control unit includes a switching valve assembly determining pressure of a pressure portion side of the sliding valve, a high pressure connection pipe connected to a high pressure side inlet of the switching valve assembly and providing a high-pressure atmosphere, a low-pressure connection pipe connected to a low pressure side inlet of the switching valve assembly and providing a low-pressure atmosphere, and a common connection pipe connecting a common side outlet of the switching valve assembly to the bypass hole and providing a high-pressure atmosphere or a low-pressure atmosphere to a pressure portion of the sliding valve.

21. The scroll compressor of claim 19, wherein the switching valve assembly includes a switching valve housing including the high-pressure side inlet, the low-pressure side inlet and the common side outlet, a switching valve slidlingly coupled to the inside of the switching valve assembly and selectively connecting the high-pressure side inlet to the common side outlet or the low-pressure side inlet to the common side outlet, an electromagnet installed at one side of the switching valve housing and moving the switching valve by applied power, and an elastic member returning the switching valve to an initial position when power being applied to the electromagnet is cut off.

22. The scroll compressor of claim 20, wherein the switching valve assembly includes a switching valve housing including the high-pressure side inlet, the low-pressure side inlet and the common side outlet, a switching valve slidlingly coupled to the inside of the switching valve assembly and selectively connecting the high-pressure side inlet to the common side outlet or the low-pressure side inlet to the common side outlet, an electromagnet installed at one side of the switching valve housing and moving the switching valve by applied power, and an elastic member returning the switching valve to an initial position when power being applied to the electromagnet is cut off.
